(19) United States
(12) Patent Application Publication
(10) Pub. No.: US 2002/0012429 A1
(43) Pub. Date: Jan. 31, 2002

(54) Interference-signal-dependent adaptive echo suppression

(75) Inventors: Hans Jurgen Matt, Remseck (DE); Detlef Hartmann, Berlin (DE); Fritz Weinschenk, Aichwald (DE); Michael Walker, Baltmannsweiler (DE)

Correspondence Address: SUGHRUE, MION ZINN, MACPEAK & SEAS, PLLC, 2100 Pennsylvania Avenue, N.W., Washington, DC, 20037-3213, US

(73) Assignee: ALCATEL

(21) Appl. No.: 09/880,754

(22) Filed: Jun. 15, 2001

(30) Foreign Application Priority Data
Jun. 24, 2000 (DE) 100 30 926.7

(51) Int. Cl. H04M 9/08

(52) U.S. Cl. 379/406.01

(57) ABSTRACT

A method for reducing echo signals in telecommunications systems for the transmission of wanted acoustic signals, particularly human speech, in which the presence of echo signals is detected and/or predicted and the detected and/or predicted echo signals are subsequently suppressed or reduced is characterized in that the power value of the noise level N in the currently used telecommunications channel is continuously measured and/or estimated, and that the degree of reduction of the echo signals to be currently effected is set continuously and automatically, in dependence on the current noise level N, according to a predefined function h(N). Reduction of the echo signals can be thereby effected, inexpensively and with simplest means, so as to produce an overall acoustic perception of the transmitted telecommunications signal which sounds as comfortable as possible to the human ear, avoiding the disadvantage, compared with the prior art, that in the case of relatively loud, clearly audible noise and simultaneously large reduction of echo into the background noise due to the echo suppression, the occurrence of transient echo peaks causes “holes” to be “punched” into the otherwise uniform background noise, resulting in what is perceived, in the case of the known methods, as a disagreeable modulation of the transmitted telecommunications signal in the speech pauses.

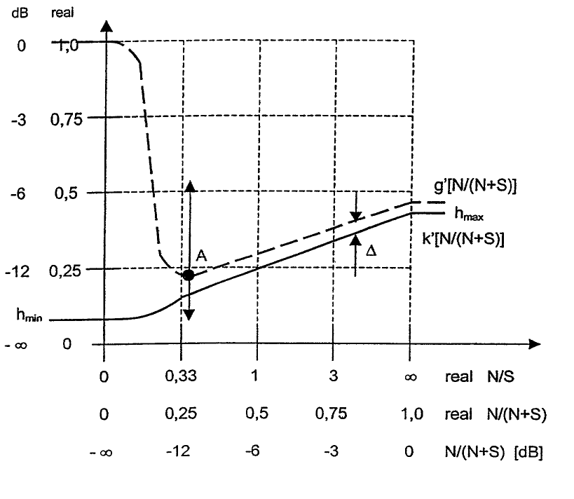

The invention concerns a method for reducing echo signals in telecommunications systems for the transmission of wanted acoustic signals, particularly human speech, in which the presence of echo signals is detected and/or predicted and the detected and/or predicted echo signals are subsequently suppressed or reduced.

Such a method is known from, for example, DE 42 29 912 A1.

Echo and noise suppression is assuming increasing importance for speech quality in communications networks, in which telephone transmissions are often noticeably affected by interference due to line or acoustic echoes and background noise.

Cordless telephones, particularly mobile telephones, are becoming increasingly widespread. In order to achieve a reasonable quality of communication with sets of ever smaller dimensions and, consequently, increasing acoustic coupling from the loudspeaker to the microphone, these sets normally comprise devices for compensating acoustic echoes. The technique of the adaptive filter for echo compensation is described in, for example, DE 44 30 189 A1.

In the case of older mobile telephones or cheaper, new mobile telephones of simple technical construction, however, substantial acoustic echoes continue to be produced which enter the PSTN (=Public Switched Telephone Network), where they seriously interfere with communication with other fixed or mobile telecommunications users. The mobile telecommunications operators therefore endeavour to eliminate these echoes in order to recruit new customers with the argument of a sound quality which is better than that of competitors.

Since the acoustic echoes are produced, but not completely suppressed, in the cheap mobile telephones, the network operators generally have no option other than to attempt to suppress the echoes in the next switching center. Ordinary adaptive filters are used to model a line echo which, with correct setting of the filter, simulates the actually occurring echoes. The modelled line echo is then subtracted from the telecommunications signal affected by the echo. However, the technique of the adaptive filter cannot be successfully used in the case of mobile telephone echoes because the original speech towards the mobile telephone is speech-coded and the echo in the mobile telephone undergoes further speech coding. For this reason, only newer, non-linear methods such as, for example, “center clippers”, controlled attenuators or NLP are suitable for the suppression of mobile telephone acoustic echoes. Adaptive filters are suitable for acoustic echoes of fixed telephones, but are generally relatively expensive.

With the introduction of methods of echo and noise reduction, the methods did not initially take account of the severity of interference with speech signals. For example, a spectral subtraction was effected with the greatest possible gain, or the degree of an echo and noise reduction was set to the highest possible values, in order to produce as good an auditory perception as possible with a reasonable, medium-level signal-to-noise ratio. All of these methods, however, produce clearly audible interference in the case of a poor signal-to-noise ratio or weak wanted signals.

Manifestly disadvantageous in the case of the known methods is the fact that, in the case of relatively loud, clearly audible noise and simultaneously large reduction of echo into the background noise due to the echo suppression, the occurrence of transient echo peaks causes “holes” to be “punched” into the otherwise uniform background noise, resulting in what is perceived as a disagreeable modulation of the transmitted telecommunications signal in the speech pauses.

The object of the present invention, by contrast, is to present a method, having the initially described features, with which reduction of the echo signals can be effected, as inexpensively as possible and with simplest means, so as to produce an overall acoustic perception of the transmitted telecommunications signal which sounds as comfortable as possible to the human ear.

This object is achieved both simply and effectively, according to the invention, in that the power value of the noise level N in the currently used telecommunications channel is continuously measured and/or estimated, and that the degree of reduction of the echo signals to be currently effected is set continuously and automatically, in dependence on the current noise level N, according to a predefined function h(N).

The degree of an echo reduction or echo suppression is thus automatically and simultaneously controlled by the currently occurring power value N of the noise, matched to the current noise value in the telephone channel and corrected in a predetermined, defined manner. The subjective perception of the resultant overall signal can also be adjusted through the selection of the function h(N). The occurrence of “holes” in the background noise due to an excessive echo suppression is effectively avoided by the method according to the invention.

By use of the method according to the invention, the input-side noise signal N is advantageously reduced, by multiplication by the factor h(N), to a value NA, according to the equation N_{A}=N*h(N).

A preferred embodiment of the method according to the invention is characterized by the fact that the function h(N) increases as N increases, whereby

h(N<<0 dBₘ)=hₘᵢₙ=const. and h(N≈0 dBₘ)=hₘₐₓ>hₘᵢₙ.

A particularly favourable psychoacoustic auditory perception of the telecommunications signals is achieved, following implementation of the echo reduction according to the invention, if

−50 dB<hₘᵢₙ<−20 dB, preferably −45 dB≦hₘᵢₙ≦−35 dB and

−20 dB<hₘₐₓ<0 dB, preferably −12 dB≦hₘₐₓ≦−6 dB.

Particularly preferred is a variant of the method according to the invention which is characterized by the fact that the predefined function h(N) is a function k(S/N) which depends on the signal-to-noise ratio, i.e., the quotient S/N from the power value of the signal level S of the wanted signals to be transmitted and the power value of the noise level N, or that the predefined function h(N) is a function k′(N/S) which depends on the reciprocal N/S of this quotient, preferably on N/(N+S).

For reasons of simpler, practical realization, a function of (S+N)/N or of (S+N)/S can also be used. Particularly practical for realization of the method on a digital signal processor (=DSP) is the use of the function k′[N/(N+S)], which runs between 0 and 1.

An advantage of the above method variant is that, in the case of large variation of the wanted signal level S in the telephone channels of a group, the correct setting is always found for the echo reduction. In the case of the echo reduction being controlled proportionally in relation to the reciprocal N/S or N/(N+S), the function k′ can be easily implemented on a DSP with fixed computer word lengths, for example, of 16 bits, through the use of particularly simple software since, for N/S or N/(N+S), a number range of preferably 0<N/S or N/(N+S)<1 is relevant or useful for controlling the noise reduction.

During normal person-to-person communication, the amplitude of the spoken speech is generally adapted automatically to the acoustic environment. In the case of a speech communication between distant locations, however, the conversing partners are not located in the same acoustic environment and are each therefore unaware of the acoustic situation at the location of the other conversing partner.

A particularly aggravated problem therefore occurs if one of the partners is compelled by their acoustic environment to speak very loudly while the other partner, in a quiet acoustic environment, produces speech signals of low amplitude. Added to this is the problem that an “electronically generated” noise is also produced on a telecommunications channel and is simultaneously transmitted as background to the wanted signal. Furthermore, it is also advantageous to reduce or suppress interference signals such as unwanted background noise (street noise, factory noise, office noise, canteen noise, aircraft noise, etc.). In order to improve auditory comfort in telephoning, it is generally sought to keep noise of all kinds to a minimum.

In addition to the recognition and reduction of echo signals according to the invention, noise signals in the telecommunications channel are preferably also suppressed or reduced. An auditorially adapted noise reduction can thus be advantageously combined with an echo reduction, working independently of the noise reduction.

In the case of the known compander method as described in, for example, the initially cited DE 42 29 912 A1, the degree of noise reduction is determined according to a set, predefined transfer function.

The compander, firstly, has the characteristic of transferring speech signals with a determined (pre-set) “normal speech signal level” (sometimes referred to as normal loudness) virtually unchanged from its input to the output.

If, however, the input signal happens to be too loud due, for example, to one speaker being too close to their microphone, a dynamic compressor limits the output level to virtually the same value as in the normal case through linear reduction of the current gain in the compander as the input loudness increases. Due to this characteristic, the speech at the output of the compander system remains at approximately the same loudness—irrespective of the extent of fluctuation of the input loudness.

If, on the other hand, a signal is input to the compander at a level which is less than the normal level, the signal undergoes additional attenuation through reduction of the gain in order that, as far as possible, only attenuated background noise is transmitted. The compander thus comprises two sub-functions, a compressor for speech signal levels which are greater than or equal to a normal level, and an expander for signal levels which are less than the normal level.

Particularly preferred is a variant of the above embodiment of the method according to the invention in which the degree of reduction of the noise level N to be currently effected is set continuously and automatically, in dependence on the current noise level N, according to a predefined function f(N) or g(S/N) or g′(N/S), preferably g′(N/[N+S]). The degree of the noise reduction is thus determined according to the particular situation and used to control a noise suppression. This, by simple means, enables an overall acoustic perception to be produced which is as comfortable as possible to the human ear and can be adapted to individual requirements according to preference.

A further advantage of this particularly preferred method variant is that, in the case of a group of telephone channels, for example between international switching centers, the noise situation, which can of course vary greatly from one channel to another, can be automatically set and individually optimized in each separate channel.

Particularly good results are achieved with this noise reduction method variant if, for N<<0 dBₘ, the functions f(N), g(S/N), g′(N/S) or g′([N/N+S]) each begin, respectively, with a constant maximum value fₘₐₓ or gₘₐₓ or g′ₘₐₓ≈1 (corresponding to 0 dB), fall to a minimum value fₘᵢₙ or gₘᵢₙ or g′ₘᵢₙ respectively in the range between N=−15 dBₘ to −10 dBₘ, preferably for N or S/N≈−12 dB, and then rise, to N≈0 dBₘ, to a constant value f₀>fₘᵢₙ or g₀>gₘᵢₙ or g′₀>g′ₘᵢₙ respectively, wherein f₀, g₀, g′₀<1 (corresponding to 0 dB), preferably 0.35<f₀, g₀, g′₀<0.75 (which corresponds to an interval −12 dB<f₀, g₀, g′₀<−3 dB).

Acoustic auditory tests have shown that, for S/N=0 dB, the speech is already so greatly affected by interference that the noise can be reduced only relatively, by a value f₀ or g₀ between −5 and −10 dB, preferably between −6 and −8 dB, in order that the overall acoustic perception is not impaired in respect of naturalness of the speech. In the case of even less favourable values of the signal-to-noise ratio S/N<0 dB, the value f₀ or g₀ can then only be maintained, since each further noise reduction only impairs the overall perception.

According to these studies, a greater noise reduction can be effected in the case of a medium-level S/N. A minimum is obtained in the range 10 dB to 15 dB. The noise reduction value fₘᵢₙ or gₘᵢₙ can be settable between −3 dB and −30 dB and, at maximum, should be between −12 dB and −30 dB, preferably approximately −18 dB.

In the case of very good signal-to-noise ratios S/N>40 dB, only a minimal reduction should be set, between 0 and −3 dB, in order maintain as far as possible the naturalness of the transmitted speech. According to ITU-T G. 168 for echo cancellers, a noise at S/N>40 dB is to be left unchanged, this corresponding to a numerical value fₘₐₓ or gₘₐₓ=1 (corresponding to 0 dB).

The sound and intelligibility of the speech are particularly good if the functions h(N), f(N), k(S/N), g(S/N) or k′(N/S) and g′(N/S) connect together in a continuous manner beyond the three ranges discussed above, rapid changes in N or in S/N being advantageously smoothed through filtering operations.

A relatively simple hardware and/or software realization is achieved in that the said functions h(N), f(N), k(S/N), g(S/N) or k′(N/S) and g′(N/S) are approximated by straight characteristic portions between the three operating points described above (sectional linear approximation).

In the case of a variant of the method according to the invention which is somewhat more complex but which results in a better tonal response, a polynomial function is used for implementation of the continuous functions h(N), f(N), k(S/N), g(S/N) or k′(N/S) and g′(N/S) in the three discussed ranges, resulting in a kind of asymmetric bell-shaped function.

For a satisfactory compromise between complexity and tonal response, defined sections of the above-mentioned functions can be realized by straight characteristic portions and other sections by a polynomial function.

Particularly preferred is a variant of the method according to the invention in which the functions h(N), f(N), k(S/N), g(S/N) or k′(N/S) and g′(N/S) are selected so that the reduction of the noise level N is auditorially adapted according to the psychoacoustic mean values of the human auditory spectrum. In this case, the value for S and/or N is determined not only from the instantaneous power value alone, but also from a weighted spectral course of S or N and an auditorially adapted noise reduction, i.e., a psychoacoustically comfortable-sounding noise reduction, is achieved overall through the function obtained thus. Since there is no measure of an acoustically comfortable-sounding noise reduction which can be easily represented, all quality evaluations are assigned to comprehensive auditory tests which are then evaluated by means of statistical methods optimized for that purpose, in order to obtain an evaluation criterion (in a manner similar to that in the case of speech codes).

A good estimation of noise level requires a good speech pause detector, since only then is it possible to be certain that only interfering noise is present in the speech pause intervals rather than some mixture of noise and traces of speech, as frequently occurs in practice.

In order to achieve an effective noise reduction, the power value of the signal to be transmitted is preferably reduced during the speech pauses according to an exponential function. A substantial noise reduction is already achieved by this means. During the speech intervals, noises are at least partially masked by the speech itself and are therefore less noticeable overall. Furthermore, a reduction of noise during a speech pause imposes appreciably less strain on the hearing by substantially reducing the deafness effect following exposure to loud sound. Upon resumption of speech, the ear can react with greater sensitivity and listen with greater accuracy.

Also particularly preferred is a method variant which is characterized by the fact that, in the speech pause detector, from the input signal x, a short-time output signal sam(x) is formed by means of a short-time level estimator, a medium-time output signal mam(x) is formed by means of a medium-time level estimator and a long-time output signal lam(x) is formed by means of a long-time level estimator, that the three output signals sam(x), mam(x) and lam(x) are set, by means of appropriate gain coefficients, so that they are of approximately equal magnitude f the input signal x is a pure noise signal, it being the case that sam(x)<mam(x)<lam(x), that the three output signals sam(x), mam(x) and lam(x) are monitored by comparators, and that the presence of a speech signal is assumed as the input signal x if sam(x) and mam(x) each become initially greater than lam(x) and the presence of a speech pause is assumed if sam(x) and/or mam(x) subsequently becomes less than lam(x).

By means of these relatively simple methods of forming different mean values of the time signal, it is already possible to effect surprisingly good speech pause detection requiring only a very small amount of computation effort.

A development of this method variant provides for the three output signals sam(x), mam(x) and lam(x) being applied, for the purpose of speech pause estimation, to a neural network which has been trained with a plurality of scenarios with different input signals x. A neural network can advantageously map linear and non-linear relationships between a large quantity of input parameters and the desired output values. A prerequisite for this is that the neural network has been trained once with a sufficient quantity of input values and associated output values. For this reason, neural networks are particularly suitable for the task of speech pause detection in the presence of different interfering noises.

It is expedient to separate noise reduction control from echo reduction control, since noises and echoes occur independently of one another and generally also have completely different physical causes. However, it is possible to state mathematically a general reduction function R, which describes a reduction of signal levels for both noises and echoes:

R(S, N, ES, τ_{E}, ERL, thrs)˜g(S/N)·d(N, ES, τ_{E}, ERL, thrs),

wherein g(S/N) denotes the noise reduction described above and d( . . . ) denotes the noise-dependent echo reduction to be applied independently and additionally if the estimated echo signal exceeds the predefined threshold value thrs.

Particularly advantageous is a method variant in which an artificial noise signal is also added to the wanted signal during an echo reduction period. When a noise level is constant, a noise reduction is likewise constant. An additional echo reduction occurring suddenly in the rhythm of the speech also means a noise reduction (at least in the short time interval) in the speech rhythm. This results in a pulsed background noise, which does not sound natural. It is therefore advantageous to add a synthetic noise of an appropriate noise generator, of the order of magnitude of the normal background noise, to the processed signal in the instants of an additional echo reduction. The purpose of this is to relay a background noise which, for the listener, is as uniform as possible. The “holes” in the background noise due to the echo reduction, discussed above, can thus be at least partially “filled in”.

The noise generator can be designed so that the artificial noise signal comprises a signal sequence which is perceived psychoacoustically as an acoustically comfortable noise (=comfort noise).

Instead of a synthetic background noise, however, it is also possible to insert into the echo time intervals, at matched intensity, a portion of a previously recorded real background noise. The added noise is then virtually indistinguishable from the previous noise and will therefore cause scarcely any acoustically interfering variations for the listener. Only at the switching centers can discrepancies occur very briefly between the original noise and the added noise.

If correctly matched to one another, the addition of noise for the purpose acoustic masking of effects and the measures for separate processing of noise and echoes will result in a particularly intelligible and comfortable speech perception, even in the case of a “difficult” environment (echoes plus noise).

Also included within the scope of the present invention is a server unit for supporting the method according to the invention described above and a computer program for executing the method. The method can be realized both as a hardware circuit and in the form of a computer program. Nowadays, software programming for powerful DSPs is preferred, since new knowledge and additional functions can be more easily implemented by altering the software on an existing hardware base. However, methods can also be implemented as hardware modules, for example in telecommunications terminal devices or telephone equipment.

Further advantages of the invention are disclosed by the description and the drawing. The features stated above and those to be stated below can also each be applied, according to the invention, either singly or multiply in any combinations. The embodiments represented and described are not to be understood as a definitive list but are rather of an exemplary character for the purpose of describing the invention.

The invention is represented in the drawing and is described more fully with reference to embodiment examples.

The figure shows an actual embodiment example for the functions k′[N/(N+S)] and g′[N/(N+S)].

### EXAMPLE

### Calculation of a Pair g′(.) and k′(.)

i) The desired function g′(.)=NLA(.) for noise reduction can be described by, for example, combining straight-line portions with portions of a polynomial function; in the simplest case, for example, by means of a polynomial of nth degree (2<n<5) and a straight line. The noise reduction factor NLA (as gain value) is thus obtained according to equation (1):

$${g}^{′} ( . ) = \{ \begin{matrix}if ( x = N / ( N + S ) \leq - 40 dB & then {g}^{′} ( . ) = 1 \\ if ( - 40 dB < x = N / ( N + S ) \leq - 12 dB ) & then \\ {g}^{′} ( . ) = {a}_{n} {x}^{n} + {a}_{n - 1} {x}^{n - 1} + … + {a}_{1} x + {a}_{0} & \text{(polynomial portion)} \\ if ( - 12 dB < x = N / ( N + S ) \leq 0 dB & then \\ {g}^{′} ( . ) = mx + c & \text{(straight line)}\end{matrix} \qquad ( 1 )$$

The coefficients {aₙ, aₙ₋₁, . . . a₁, a₀} of the polynomial and the coefficients {m, c} of the straight line are calculated so that they coincide at the desired point A.

ii) The associated function of the echo damping ERLE[N/(N+S)]=k′(.) can also be described by, for example, combining straight-line portions with portions of a polynomial function. In this example, according to equation (2), it is preferably composed of two straight-line portions which are selected so that they are suitably matched to the particular situation.

$${k}^{′} ( . ) = \{ \begin{matrix}if ( x = N / ( N + S ) \leq - 12 dB & then \\ {k}^{′} ( . ) = x ( \frac{{g}^{′} ( A ) \cdot Δ - {h}_{min}}{0.25} ) + {h}_{min} & \text{(straight line portion 1)} \\ if ( - 12 dB < x = N / ( N + S ) \leq 0 dB ) & then \\ {k}^{′} ( . ) = {g}^{′} ( x ) Δ & \text{(straight line portion 2)}\end{matrix} \qquad ( 2 )$$

In this equation, g′(A) denotes the numerical value (real) of g′(.) at the point “A” and Δ denotes a factor by which this value is reduced so that the function k′(.) runs parallel to the function g′(.), at a distance of Δ.

According to Rec. ITU-T G.168, a noise to a level of −40 dB at the input of an echo canceller is to be unchanged, i.e., is to be transmitted at the same level. This functionality is fulfilled by the first condition for g′(.) according to equation (1).

It is particularly advantageous if, in the position of the point A, the magnitude of hₘᵢₙ and the distance Δ between the two functions g′ and k′ can be freely selected and set according to the actual requirements in the particular case. In displacement of the point A, the function k′ should adjust automatically to the changed function g′.

1. Method for reducing echo signals in telecommunications systems for the transmission of wanted acoustic signals, particularly human speech, in which the presence of echo signals is detected and/or predicted and the detected and/or predicted echo signals are subsequently suppressed or reduced,
characterized in that
the power value of the noise level N in the currently used telecommunications channel is continuously measured and/or estimated, and that the degree of reduction of the echo signals to be currently effected is set continuously and automatically, in dependence on the current noise level N, according to a predefined function h(N).

2. Method according to claim 1, characterized in that the function h(N) increases as N increases, whereby h(N<<0 dBₘ)=hₘᵢₙ=const. and h(N≈0 dBₘ)=hₘₐₓ>hₘᵢₙ.

3. Method according to claim 2, characterized in that:
−50 dB<hₘᵢₙ<−20 dB, preferably −45 dB≦hₘᵢₙ≦−35 dB and
−20 dB<hₘₐₓ<0 dB, preferably −12 dB≦hₘₐₓ≦−6 dB.

4. Method according to claim 1, characterized in that the predefined function h(N) is a function k(S/N) which depends on the signal-to-noise ratio, i.e., the quotient S/N from the power value of the signal level S of the wanted signals to be transmitted and the power value of the noise level N, or that the predefined function h(N) is a function k′(N/S) which depends on the reciprocal N/S of this quotient, preferably on N/(N+S).

5. Method according to claim 1, characterized in that, in addition to the recognition and reduction of echo signals, noise signals are also suppressed or reduced.

6. Method according to claim 5, characterized in that the degree of reduction of the noise level N to be currently effected is set continuously and automatically, in dependence on the current noise level N, according to a predefined function f(N) or g(S/N) or g′(N/S), preferably g′(N/[N+S]).

7. Method according to claim 6, characterized in that, for N<<0 dBₘ, the functions f(N), g(S/N), g′(N/S) or g′([N/N+S]) each begin, respectively, with a constant maximum value fₘₐₓ or gₘₐₓ or g′ₘₐₓ≈0, fall to, in particular, a settable value, preferably a minimum value fₘᵢₙ or gₘᵢₙ or g′ₘᵢₙ respectively in the range between N=−15 dBₘ to −10 dBₘ, preferably for N or S/N≈−12 dBₘ, and then rise, to N≈0 dBₘ, to a constant value f₀>fₘᵢₙ or g₀>gₘᵢₙ or g′₀>g′ₘᵢₙ, wherein f₀, g₀, g′₀<0.

8. Method according to claim 7, characterized in that:
f₀≦−5 dB, g₀≧−10 dB, preferably f₀≦−6 dB, g₀≧−8 dB, and
fₘᵢₙ≦−20 dB, gₘᵢₙ≧−30 dB, preferably fₘᵢₙ, gₘᵢₙ≈−25 dB.

9. Method according to claim 1, characterized in that the function h(N), at least partially, and preferably in all sub-sections, runs linearly with N.

10. Method according to claim 4, characterized in the functions k(S/N) and k′(N/S), at least partially, and preferably in all sub-sections, run linearly with S/N and N/S or N/(N+S) respectively.

11. Method according to claim 1, characterized in that the function h(N) is constructed of polynomials and runs over N as an asymmetric bell-shaped curve.

12. Method according to claim 4, characterized in that the functions k(S/N) and k′(N/S) are constructed of polynomials and run over S/N and N/S respectively as asymmetric bell-shaped curves.

13. Method according to claim 1, characterized in that the function k(N) is selected so that the reduction of the noise level N is auditorially adapted according to the psychoacoustic mean values of the human auditory spectrum.

14. Method according to claim 4, characterized in that the functions k(S/N) and k′(N/S) are each respectively selected so that the reduction of the noise level N is auditorially adapted according to the psychoacoustic mean values of the human auditory spectrum.

15. Method according to claim 1, characterized in that a speech pause detector (SPD) is used for recognition of the noise level N.

16. Method according to claim 15, characterized in that the power value of the signal to be transmitted is reduced during the speech pauses according to an exponential function.

17. Method according to claim 5, characterized in that the reduction of noise signals and the reduction of echo signals are controlled separately.

18. Method according to claim 1, characterized in that an artificial noise signal is also added to the wanted signal during an echo reduction period.

19. Method according to claim 18, characterized in that the artificial noise signal comprises a signal sequence which is perceived psychoacoustically as an acoustically comfortable noise (=comfort noise).

20. Method according to claim 18, characterized in that the artificial noise signal comprises a noise signal recorded previously during the current telecommunications connection.
